(19) United States
(12) Patent Application Publication
(10) Pub. No.: US 2007/0132193 A1
(43) Pub. Date: Jun. 14, 2007

(54) Compliant abradable sealing system and method for rotary machines

(76) Inventors: Christopher Edward Wolfe, Niskayuna, NY (US); Farshad Ghasripoor, Scotia, NY (US); Mohsen Salehi, Watervliet, NY (US); Bruce William Brisson, Galway, NY (US)

Correspondence Address: Patrick S. Yoder;FLETCHER YODER, P.O. Box 692289, Houston, TX, 77269-2289, US

(21) Appl. No.: 11/301,721

(22) Filed: Dec. 13, 2005

(51) Int. Cl. F16J 15/447

(52) U.S. Cl. 277/415

(57) ABSTRACT

A method for operating a compliant abradable sealing system includes biasing a radially movable sealing element to contact a mating radially fixed sealing element. The radially fixed sealing element is rotated relative to the radially movable sealing element. The radially fixed sealing element is provided on a rotor. The radially movable sealing element is provided in a stator housing. The radial movement of the movable sealing element is limited by a stopping device provided between the movable sealing element and the stator housing. A plurality of permanent sealing grooves are formed in the radially movable sealing element to form a zero-clearance labyrinth seal.

### BACKGROUND

The invention relates generally to rotary machines, and in particular to a compliant abradable sealing system for a rotary compressor, and method for a operating a compliant abradable sealing system for facilitating a minimum dynamic clearance during steady state and transient operating conditions of a rotary compressor.

Efficiency of rotary devices utilized for pumping a fluid or compressing a vapor (e.g. gas) depends upon the internal tolerances of the components comprising the device. A loosely-toleranced rotary pump or compressor may have a relatively poor fit between internal components and may therefore exhibit poor efficiency, with relatively high leakage occurring within the device from regions of high pressure to regions of lower pressure. The traditional approach to this situation is to decrease the amount of clearance on these critical interfaces.

Sealing systems are used in rotary machines such as turbines, compressors, or the like to reduce leakage of fluid flowing through the rotary machines. Fluid leakage through the rotary machines is generally undesirable for various reasons. For example, fluid leakage between the rotor and a circumferentially surrounding casing of a compressor may lower the efficiency of the compressor leading to increased fuel costs.

To reduce the leakage of fluid in rotary compressors, labyrinth seals or honeycomb seals are sometimes used. Sealing strips in such arrangements are typically disposed between the rotor and the stationary casing. The effectiveness of the seal depends on maintaining a desired clearance between the sealing strips and the rotor. If the clearance exceeds a desired amount, efficiency of the compressor is lowered. Running clearances may deviate from design intent due to misalignment between rotor and casing, and during transients such as start-up, the rotor may expand relative to the casing or sweep through orbits, causing the rotor and stationary components to interfere (i.e., contact one another). As a result, seal components, which are provided on the rotor as well as the stator, may be damaged.

Accordingly, there is a need for a technique that reduces leakage of fluid in a rotary machine, and that maintains minimum clearance without impairing the performance of a seal during steady state and transient operating conditions. In addition, a system for reducing leakage of fluid in a rotary machine during steady state and transient operating conditions is also desirable.

### BRIEF DESCRIPTION

In accordance with one aspect of the present invention, a method for operating a compliant abradable sealing system includes biasing a radially movable sealing element to contact a mating radially fixed sealing element. The radially fixed sealing element is rotated relative to the radially movable sealing element. A plurality of permanent sealing grooves are formed in the radially movable sealing element to form a zero-clearance labyrinth seal between the radially movable sealing element and the radially fixed sealing element.

In accordance with another aspect of the present invention, a compliant abradable sealing system includes at least one biasing member. A radially movable sealing element is coupled to at least one biasing member and configured to contact a mating radially fixed sealing element. The radially fixed sealing element is rotatable relative to the radially movable sealing element to form a plurality of permanent sealing grooves in the radially movable sealing element to form a zero-clearance labyrinth seal therebetween.

In accordance with another aspect of the present invention, a rotary compressor includes a rotor disposed in a stator housing. A compliant abradable sealing system is disposed between the rotor and the stator housing and configured to control leakage of a fluid flowing through the compressor. The sealing system includes at least one biasing member. A radially movable sealing element is coupled to at least one biasing member and configured to contact a mating radially fixed sealing element. The radially fixed sealing element is rotatable relative to the radially movable sealing element to form a plurality of permanent sealing grooves in the radially movable sealing element to form a zero-clearance labyrinth seal therebetween.

In accordance with another aspect of the present invention, a method for improving performance of a rotary compressor includes disposing a rotor in a stator housing. A compliant abradable sealing system is disposed between the rotor and the stator housing and configured to control leakage of a fluid flowing through the compressor. A radially movable sealing element is coupled to at least one biasing member within the stator housing. A mating radially fixed sealing element is coupled to the rotor. The radially fixed sealing element is rotated relative to the radially movable sealing element to form a plurality of permanent sealing grooves in the radially movable sealing element to form a zero-clearance labyrinth seal therebetween.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a compliant abradable sealing system for a rotary compressor in accordance with an exemplary embodiment of the present invention;

FIG. 2 is a diagrammatical view of a compliant abradable sealing system having a radially movable sealing element contacting a mating radially fixed sealing element in accordance with an exemplary embodiment of the present invention;

FIG. 3 is a diagrammatical view of a compliant abradable sealing system having a plurality of permanent sealing grooves formed in a radially movable sealing element during starting condition of a rotary compressor in accordance with an exemplary embodiment of the present invention;

FIG. 4 is a diagrammatical view of a compliant abradable sealing system having a radially movable sealing element biased against a mating radially fixed sealing element during transient operating conditions of a rotary compressor in accordance with an exemplary embodiment of the present invention;

FIG. 5 is a diagrammatical view of a compliant abradable sealing system having a radially movable sealing element biased against a mating radially fixed sealing element in which interaction between the radially movable sealing element and the radially fixed sealing element is axial during transient operating conditions of a rotary compressor in accordance with an exemplary embodiment of the present invention;

FIG. 6 is a diagrammatical view of a compliant abradable sealing system having a plurality of teeth engaging a plurality of permanent sealing grooves during steady state operating conditions of a rotary compressor in accordance with an exemplary embodiment of the present invention;

FIG. 7 is a diagrammatical view of a compliant abradable sealing system having a radially movable sealing element contacting a mating radially fixed sealing element in accordance with an exemplary embodiment of the present invention;

FIG. 8 is a diagrammatical view of a compliant abradable sealing system having a plurality of teeth detachably fitted to a rotor of a rotary compressor in accordance with an exemplary embodiment of the present invention;

FIG. 9 is a flow chart illustrating exemplary steps involved in method of operating a compliant abradable sealing system in accordance with an exemplary embodiment of the present invention; and

FIG. 10 is a flow chart illustrating exemplary steps involved in method of improving performance of a rotary compressor in accordance with an exemplary embodiment of the present invention.

### DETAILED DESCRIPTION

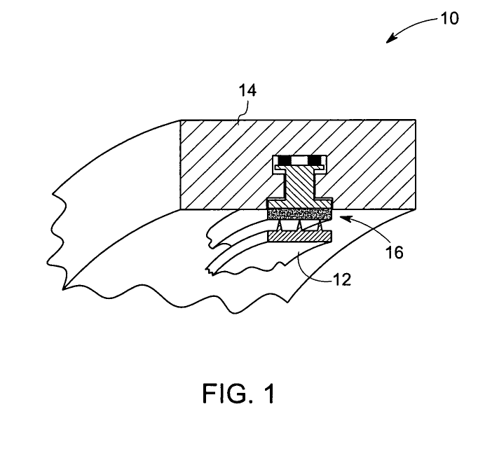

As discussed in detail below, aspects of the present invention provide a compliant abradable sealing system for a rotary machine having a radially movable sealing element configured to contact a mating radially fixed sealing element. The radially fixed sealing element is rotatable relative to the radially movable sealing element to form a plurality of permanent sealing grooves in the radially fixed sealing element or in the radially movable sealing element. During transient operating conditions of the rotary machine, the compliant abradable sealing system facilitates minimum clearance between a rotor and a stator casing. As a result, fluid leakage through the rotary machine is minimized and the overall efficiency is enhanced. Also disclosed is a method of operating the compliant abradable sealing system. Specific embodiments of the present invention are discussed below referring generally to FIGS. 1-8.

Referring to FIG. 1, a rotary machine (for example, a rotary compressor) 10 is illustrated in accordance with certain embodiments of the present invention. The rotary compressor 10 includes a rotor 12 disposed inside a stator housing 14. The rotor 12 is coupled to an input drive shaft (not shown). As known to those skilled in the art, the stator housing 14 includes a plurality of suction ports and discharge ports (not shown) communicating gases to or from the rotor 12. During rotation of the rotor 12, fluid is sucked through the suction ports and the compressed fluid is discharged through the discharge ports. An abradable sealing system 16 is provided between the rotor 12 and the stator housing 14 and configured to control the leakage of fluid between the rotor 12 and the stator housing 14. The sealing system 16 is assembled with interference between its components to eliminate typical clearances between the rotor 12 and the stator housing 14. Although in the illustrated embodiment, the rotary compressor is illustrated, in other exemplary embodiments, the sealing system in accordance with the aspects of the present invention may be used in other rotary machines, for example, steam turbine, gas turbine, or the like.

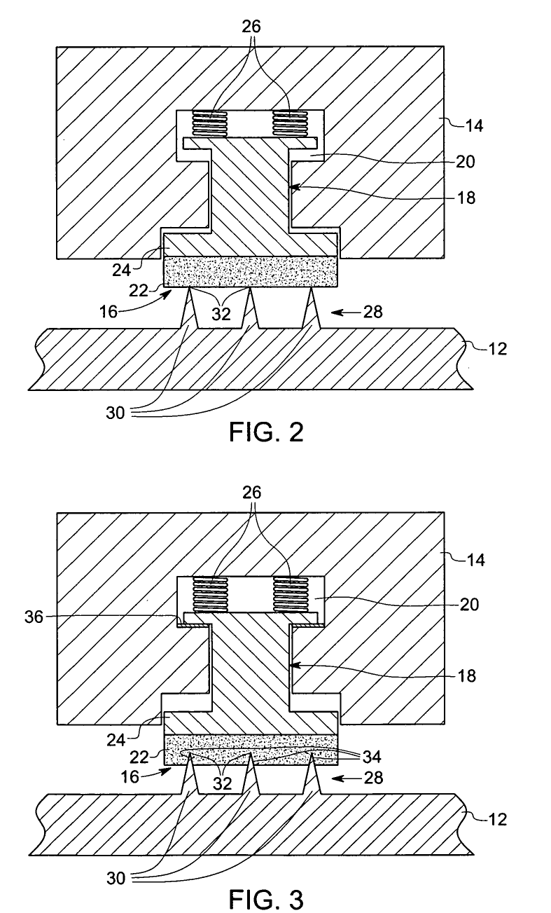

Referring to FIG. 2, the sealing system 16 in accordance with aspects of the present invention, is illustrated. As mentioned previously, the sealing system 16 is disposed between the rotor 12 and the stator housing 14. The sealing system 16 includes a radially movable sealing element 18 (e.g., an I-shaped packing ring) disposed in a slot 20 formed in the stator housing 14. The packing ring 18 includes an abradable coating 22 provided on a substrate 24. The abradable coating 22 is configured to enhance the wear resistance of the packing ring. The abradable coating 22 may be adaptable to various operating conditions, such as operating temperature of the sealing system 16, rotor speed, incursion rate, or the like. In another example, the abradable coating 22 may be provided at an inner periphery of a stator vane (not shown).

In one embodiment the abradable coating 22 may include an alloy of cobalt, nickel, chromium, aluminum, yttrium, hexagonal boron nitride, and polymers such as polyesters, polyimides, or the like. In another embodiment, the abradable coating typically includes nickel, chromium, aluminum, and clay (bentonite). In yet another embodiment, the abradable coating may include nickel, graphite, and stainless steel. In yet another embodiment, the abradable coating may include nickel, chromium, iron, aluminum, boron and nitrogen. In yet another embodiment, the abradable coating may also include non-metallic materials (e.g. teflon applied by electrostatic powder coating process or teflon filled synthetic mica which may be attached by a mechanical device). Similarly, in the other embodiments, other compositions of the abradable coating 22 as known to those skilled in the art are also envisaged. The abradable coating 22 may be formed on the substrate 24 by brazing or thermal spraying. In one example, the substrate may be composed of carbon steel, although other materials may be suitable, depending upon such factors as the design of the machine, it's operating temperatures and transients, the fluid treated (i.e., compressed), and so forth.

A plurality of biasing members 26 such as springs are disposed between the packing ring 18 and the stator housing 20. Exemplary springs may include leaf springs, coil springs, helical springs, stacked belleville washers provided in a housing or the like. The springs 26 are configured to bias the packing ring 18 against a radially fixed sealing element 28 provided on the rotor 12. The packing ring 18 is radially movable with respect to the housing 14. The arrangement, number, and type of springs may be varied depending on the application. In certain exemplary embodiments, the springs may be used in conjunction with other biasing mechanisms for providing a force to bias the packing ring 18 against the radially fixed sealing element 28. For example, the springs may be used in conjunction with gas pressures for providing a force to bias the packing ring 18 against the radially fixed sealing element 28. In the illustrated embodiment, the radially fixed sealing element 28 includes a plurality of teeth 30 formed integrally on the rotor 12.

During assembly, the sealing system 16 is provided between the rotor 12 and the stator housing 14 in such a way that tip portions 32 of the plurality of teeth 30 contact the abradable coating 22 of the packing ring 18. The height of the teeth corresponds to the maximum radial incursion of teeth 30 into the abradable coating 22 of the packing ring 18. The abradable coating 22 typically protects packing ring 18 against possible wear due to interference between the packing ring 18, itself, and the plurality of teeth 30 during typical operating conditions, such as during start-up, and transient conditions of the rotary compressor.

Referring to FIG. 3, the sealing system 16 in accordance with aspects of the present invention, during starting condition of the rotary compressor is illustrated. As discussed previously, the sealing system 16 includes the shaped packing ring 18 disposed in the slot 20 formed in the stator housing 14. The springs 26 bias the packing ring against the tip portions 32 of the plurality of teeth 30 provided on the rotor 12.

During start up of the rotary compressor, the tip portions 32 of the plurality of teeth 30 slide over the surface of the abradable coating 22 due to the interference between the packing ring 18 and the teeth 30. The combined effect of centrifugal forces and the forces resulting from biasing the packing ring 18 against the teeth 30 dislodges the particles in the abradable coating 22, causing an incursion of the teeth 30 in the abradable coating 22. As a result, a plurality of permanent sealing grooves 34 are formed in the abradable coating 22. In one example, during start-up operation of the rotary compressor, the sealing grooves 34 have a profile matching as that of the teeth 30. As a result, close clearance is maintained between the sealing elements. The location, number and height of the teeth 30 may be varied as appreciated by those skilled in the art. The abradable coating 22 has a porosity and hardness that prevents rupture, delamination, and damage to the rotor 12 during rubbing. In the illustrated embodiment, the sealing system 16 may include a stopping device 36 provided in the slot 20 of the stator housing 14 and configured to control the radial movement of the packing ring 18 so as to adjust the depth of the grooves 34 formed in the abradable coating 22 of the packing ring 18.

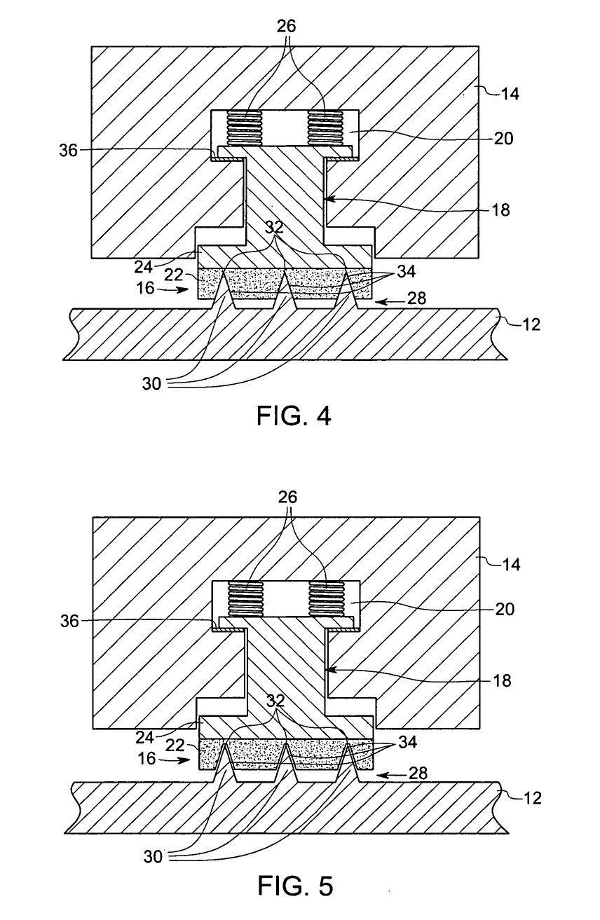

Referring to FIG. 4, the sealing system 16 in accordance with aspects of the present invention, during transient operating conditions of the rotary compressor is illustrated. As described above, during start up of the rotary compressor, the tip portions 32 of the plurality of teeth 30 slide over the surface of the abradable coating 22 due to the interference between the packing ring 18 and the teeth 30. The plurality of permanent sealing grooves 34 are formed in the abradable coating 22. During transient operating conditions, misalignment occurs between the rotor 12 and the stator housing 14, causing the rotor 12 to be pushed against the stator housing 14. As a result, the teeth 30 are engaged in the grooves 34 to form a zero-clearance labyrinth seal. Maintaining a zero-clearance between the sealing elements 18, 28 beneficially reduces leakage through gap between the rotor 12 and the stator housing 14. Reducing leakage of fluid through the rotary compressor enhances the overall efficiency and performance of the rotary compressor.

It should be noted that, as used herein, the term “zero clearance” denotes the overlap in the maximum outer perimeter of inner elements of the sealing system, and the maximum inner perimeter of the outer elements. That is, in the embodiment described above, during operation of the compressor, the teeth 30 have an outer diameter that is greater than the inner diameter of the coating 22. It is this zero clearance that initially forms the grooves 34, and that locates the teeth back in the grooves for sealing thereafter.

Referring to FIG. 5, another exemplary embodiment of the sealing system 16 in accordance with aspects of the present invention is illustrated. During start up of the rotary compressor, the tip portions 32 of the plurality of teeth 30 slides over the surface of the abradable coating 22 due to the interference between the packing ring 18 and the teeth 30. The plurality of permanent sealing grooves 34 are formed in the abradable coating 22. In the illustrated embodiment, interaction between the packing ring 18 and the radially fixed sealing element may be axial. In such an embodiment, the packing ring may accommodate the axial incursion of the radially fixed sealing element.

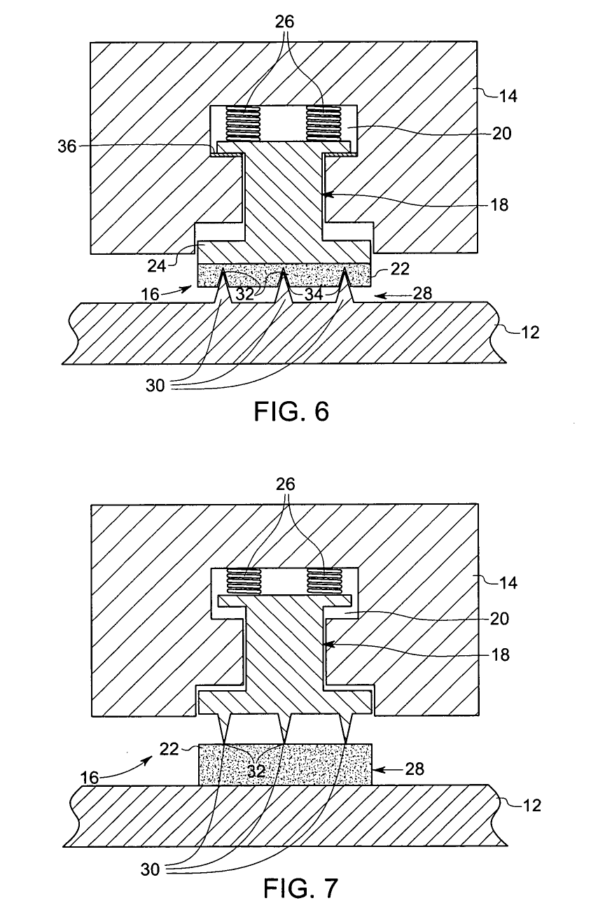

Referring to FIG. 6, the sealing system 16 in accordance with aspects of the present invention, during steady state operating conditions of the rotary compressor is illustrated. During start up of the rotary compressor, the tip portions 32 of the plurality of teeth 30 slide over the surface of the abradable coating 22 due to the interference between the packing ring 18 and the teeth 30, as described above. The plurality of permanent sealing grooves 34 are formed in the abradable coating 22. Subsequently, during steady state operating conditions, the rotor 12 is maintained at the predetermined original position relative to the stator housing 14. As a result, the teeth 30 are engaged to the grooves 34 formed in the abradable coating 22 so as to maintain a minimal clearance between the rotor 12 and the stator housing 14.

Referring to FIG. 7, another exemplary embodiment of the sealing system 16 in accordance with aspects of the present invention, is illustrated. The sealing system 16 is disposed between the rotor 12 and the stator housing 14. The sealing system 16 includes the radially movable sealing element (packing ring) 18 disposed in the slot 20 formed in the stator housing 14. A plurality of teeth 30 are provided on the packing ring 18.

The plurality of biasing members 26 such as springs are disposed between the packing ring 18 and the stator housing 20. The springs 26 are configured to bias the packing ring 18 against the radially fixed sealing element 28 provided on the rotor 12. In the illustrated embodiment, the radially fixed sealing element 28 includes the abradable coating 22 provided on the rotor 12. During assembly, the sealing system 16 is provided between the rotor 12 and the stator housing 14 in such a way that tip portions 32 of the plurality of teeth 30 contact the abradable coating 22 provided on the rotor 12. As discussed previously, during start up of the rotary compressor, the tip portions 32 of the plurality of teeth 30 slide over the surface of the abradable coating 22 due to the interference between the packing ring 18 and the coating 22. The combined effect of centrifugal forces and the forces resulting from biasing the packing ring 18 against the coating 22 dislodges the particles in the abradable coating 22, causing an incursion of the teeth 30 in the abradable coating 22. As a result, a plurality of permanent sealing grooves are formed in the abradable coating 22.

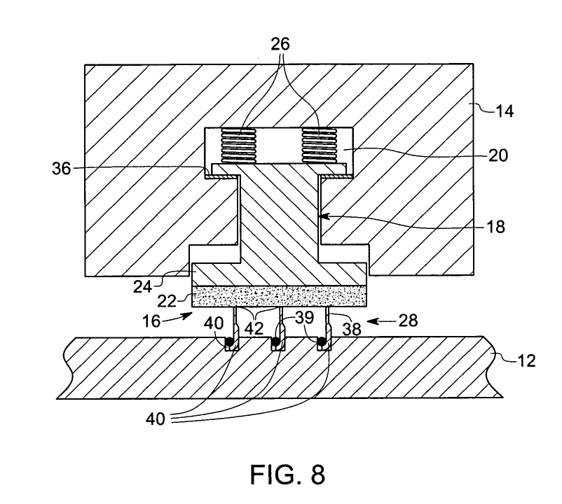

Referring to FIG. 8, another embodiment of the sealing system 16 is illustrated in accordance with aspects of the present invention. As mentioned in previous embodiments, the sealing system 16 is disposed between the rotor 12 and the stator housing 14. The sealing system 16 includes the packing ring 18 disposed in the slot 20 formed in the stator housing 20. In the illustrated embodiment, the radially fixed sealing element 28 includes a plurality of teeth 38 (e.g. “J” strip type) detachably fitted to plurality of slots 40 formed in the rotor 12. A plurality of wires 39 may be used to hold the plurality of teeth 38 in the slots 40 formed in the rotor 12. The plurality of teeth 38 protrudes radially outwards to the packing ring 18. In one example, the plurality of teeth 38 is made of stainless steel, although other materials may be employed. During assembly, the springs 26 are configured to bias the packing ring 18 against tip portions 42 of the plurality of teeth 38 fitted to the slots 40 formed in the rotor 12. The illustrated example provides the additional advantage that the plurality of teeth 38 may be replaced if the plurality of teeth 38 are damaged due to interference, due to the fact that the plurality of teeth 38 are detachably fitted to the rotor 12.

In yet another embodiment, a plurality of teeth may be detachably fitted to slots formed in the packing ring 18. The plurality of teeth protrudes downwards to a bumped surface of the rotor 12. Flow of fluid is throttled at locations where the teeths are provided on the rotor 12. The bumped surface of the rotor facilitates to divert fluid flow along a radial direction providing a more tortuous path.

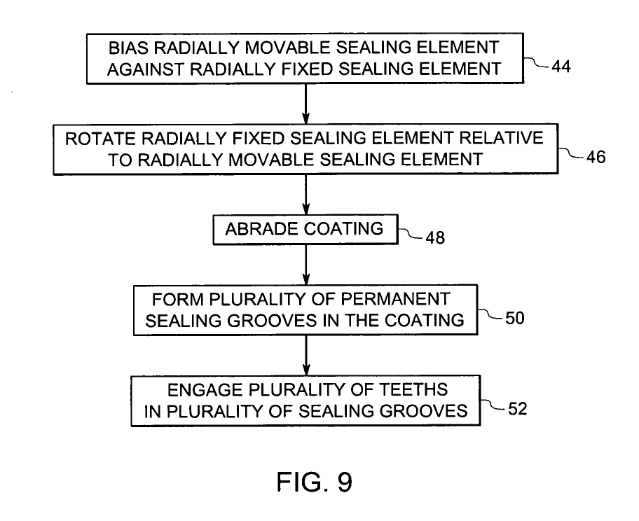

Referring to FIG. 9, a flow chart illustrating exemplary steps involved in method of operating a compliant abradable sealing system of a rotary compressor is illustrated. In accordance with the illustrated exemplary embodiment, the method includes biasing a radially movable sealing element (i.e. packing ring) provided in a stator casing, to contact a mating radially fixed sealing element (i.e. a plurality of teeth) provided on a rotor as represented by step 44. A plurality of biasing members such as springs located between the packing ring and the stator casing, bias the packing ring against the tip portions of the plurality of teeth.

When the rotary compressor operation is started, the radially fixed sealing element is rotated relative to the packing ring as represented by step 46. The tip portions of the plurality of teeth slide over the surface of an abradable coating of the packing ring due to the interference between the packing ring and the teeth as represented by step 46. The combined effect of centrifugal forces and the biasing forces dislodge the particles in the abradable coating, causing an incursion in the abradable coating as represented by step 48. As a result, a plurality of permanent sealing grooves 34 are formed in the abradable coating as represented by step 50. The depth of the grooves formed in the packing ring may be adjusted by controlling the radial movement of the packing ring via a stopping device. The height of the teeth also serve to limit their incursion into the coating material.

During transient operating conditions of the rotary compressor, expansion of the rotor, or more generally, changes in the clearance of the rotor and stator occur, causing the rotor to be pushed against the stator housing. As a result, the teeths are engaged to the grooves to form a zero-clearance labyrinth seal as represented by step 52. During steady state operating conditions of the rotary compressor, the rotor is maintained at the predetermined original position relative to the stator housing. As a result, the teeth are engaged to the grooves formed in the abradable coating 22 so as to maintain a minimal clearance between the rotor and the stator housing.

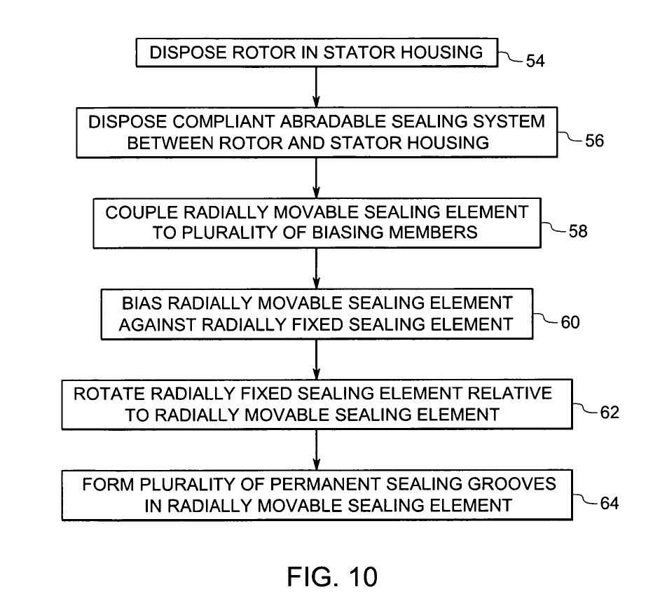

Referring to FIG. 10, a flow chart illustrating exemplary steps involved in method of improving performance of a rotary compressor is illustrated. The method includes disposing a rotor inside a stator casing as represented by step 54. At least one abradable sealing system is disposed between the rotor and the stator housing as represented by step 56. The sealing system includes a radially movable sealing element (packing ring) disposed in a slot formed in the stator casing. The method further includes disposing a plurality of biasing members such as springs between the packing ring and the stator housing as represented by step 58. The springs are disposed in such a way so as to bias the packing ring against a radially fixed sealing element (plurality of teeth) provided integrally on the rotor as represented by step 60. The process summarized in FIG. 10 may therefore serve to improve performance of existing machines, such as by retrofitting with the sealing system described above.

Thereafter, as described previously, when the rotary compressor operation is started, the radially fixed sealing element is rotated relative to the packing ring as represented by step 62. The tip portions of the plurality of teeth slides over the surface of an abradable coating of the packing ring due to the interference between the packing ring and the teeth. As a result, a plurality of permanent sealing grooves are formed in the abradable coating as represented by step 64. During transient operating conditions of the rotary compressor, changes in radial dimensions occur between the rotor and the stator housing, causing the rotor to be pushed against the stator housing. As a result, the teeths are engaged to the grooves to form a zero-clearance labyrinth seal. Leakage of fluid through the rotary compressor is thereby reduced and the overall efficiency and performance of the rotary compressor is improved.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for operating a compliant abradable sealing system comprising:
biasing a radially movable sealing element to contact a mating radially fixed sealing element;
rotating the radially fixed sealing element relative to the radially movable sealing element; and
forming a plurality of permanent sealing grooves in the radially movable sealing element to form a zero-clearance labyrinth seal between the radially movable sealing element and the radially fixed sealing element.

2. The method of claim 1, comprising biasing the radially movable sealing element to contact with the mating radially fixed sealing element using a plurality of springs.

3. The method of claim 1, wherein forming the plurality of permanent sealing grooves comprises abrading a coating formed in the radially movable sealing element.

4. The method of claim 1, wherein forming the plurality of permanent sealing grooves comprises abrading a coating formed in the radially fixed sealing element.

5. The method of claim 1, wherein forming the plurality of permanent sealing grooves comprises adjusting the depth of the grooves formed in the radially movable sealing element via a stopping device.

6. The method of claim 1, further comprising engaging a plurality of teeth formed in the radially fixed sealing element to form the plurality of permanent sealing grooves in the radially movable sealing element.

7. A compliant abradable sealing system comprising:
at least one biasing member;
a radially movable sealing element coupled to at least one biasing member and configured to contact a mating radially fixed sealing element;
wherein the radially fixed sealing element is rotatable relative to the radially movable sealing element to form a plurality of permanent sealing grooves in the radially movable sealing element to form a zero-clearance labyrinth seal therebetween.

8. The system of claim 7, wherein the at least one biasing member comprises a spring.

9. The system of claim 8, wherein the spring is configured to bias the radially movable sealing element to contact the mating radially fixed sealing element.

10. The system of claim 7, further comprising an abradable coating formed in the radially movable sealing element.

11. The system of claim 10, wherein the plurality of permanent sealing grooves are formed in the abradable coating.

12. The system of claim 10, further comprising a plurality of teeth provided in the radially fixed sealing element.

13. The system of claim 12, wherein the plurality of teeth are configured to engage the plurality of permanent sealing grooves formed in the abradable coating during normal operation of the system.

14. The system of claim 13, further comprising a stopping device configured to control the movement of the radially movable sealing element in such a way to adjust the depth of the sealing grooves formed in the radially movable sealing element.

15. The system of claim 7, further comprising an abradable coating formed in the radially fixed sealing element.

16. The system of claim 15, further comprising a plurality of teeth formed in the radially movable sealing element.

17. A rotary compressor comprising:
a rotor disposed in a stator housing; and
a compliant abradable sealing system disposed between the rotor and the stator housing and configured to control leakage of a fluid flowing through the compressor; the sealing system comprising:
at least one biasing member;
a radially movable sealing element coupled to at least one biasing member and configured to contact a mating radially fixed sealing element;
wherein the radially fixed sealing element is rotatable relative to the radially movable sealing element to form a plurality of permanent sealing grooves in the radially movable sealing element to form a zero-clearance labyrinth seal therebetween.

18. The system of claim 17, wherein the at least one biasing member comprises a spring configured to bias the radially movable sealing element to contact the mating radially fixed sealing element.

19. The system of claim 17, wherein the radially movable sealing element comprises an abradable coating disposed on a substrate.

20. The system of claim 19, wherein the plurality of permanent sealing grooves are formed in the abradable coating.

21. The system of claim 17, wherein the radially fixed element comprises a plurality of teeth provided on the rotor.

22. The system of claim 17, wherein the radially fixed element comprises a plurality of teeth detachably disposed on the rotor.

23. The system of claim 17, wherein the compliant abradable sealing system further comprises a stopping device configured to control the movement of the radially movable sealing element in such a way to adjust the depth of the grooves formed in the radially movable sealing element.

24. The system of claim 17, further comprising a plurality of teeth provided on the radially movable sealing element.

25. The system of claim 24, wherein the radially fixed element comprises an abradable coating disposed on the rotor.

26. A method for improving performance of a rotary compressor comprising:
disposing a rotor in a stator housing; and
disposing a compliant abradable sealing system between the rotor and the stator housing configured to control leakage of a fluid flowing through the compressor; disposing the sealing system comprising:
coupling a radially movable sealing element to at least one biasing member within the stator housing, and a mating radially fixed sealing element to the rotor;
rotating the radially fixed sealing element relative to the radially movable sealing element to form a plurality of permanent sealing grooves in the radially movable sealing element to form a zero-clearance labyrinth seal therebetween.

27. The method of claim 26, wherein disposing the compliant abradable sealing system comprises providing a plurality of teeth on the rotor.

28. The method of claim 26, wherein disposing the compliant abradable sealing system comprises disposing a plurality of teeth detachably on the rotor.

29. The method of claim 26, further comprising coupling a stopping device to the radially movable sealing element to control movement of the radially movable sealing element in such a way to adjust the depth of the grooves formed in the radially movable sealing element.
